(19) United States
(12) Patent Application Publication
(10) Pub. No.: US 2013/0136843 A1
(43) Pub. Date: May 30, 2013

(54) SPHERICAL PORTION OF COMPACTED GROUND COFFEE AND METHOD FOR MAKING SAME

(71) Applicant: Jean-Pierre Blanc, Nice (FR)

(72) Inventor: Jean-Pierre Blanc, Nice (FR)

(21) Appl. No.: 13/700,671

(22) PCT Filed: May 20, 2011
(86) PCT No.: PCT/EP11/58237

§ 371 Date: Feb. 14, 2013

(30) Foreign Application Priority Data
May 28, 2010 (FR) 1054171

(51) Int. Cl. A23F 5/12

(52) U.S. Cl. CPC A23F 5/125
USPC 426/595; 100/35

(57) ABSTRACT

The invention relates to a portion of product to be infused to prepare a beverage characterised in that the said portion comprises a spherical shell made of compacted ground coffee and a core made of ground coffee. The invention can be used to prepare beverages by infusing in any type of beverage preparation device, and preferably those used to prepare espressos.

The present invention relates to a spherical portion of ground coffee and its method of manufacture.

The invention finds its application in the preparation of beverages to be infused in all types of beverage making devices, more preferably those for preparing espressos.

Prepacked pods made of filter paper are already known for use with materials such as coffee, tea or chocolate powder. The material to be infused is in powder form, that is to say loose, and has to be held in this form by the filter paper. This type of pod is then enclosed in a protective layer, usually made of plastic, in order to protect the material to be infused from the effects of water, air and light. These pods have the disadvantage of increasing the amount of waste produced.

A known application to overcome the problems of waste created by the pods consists in adding a structuring product to the material to be infused allowing it to be formed without requiring the use of filter paper.

Such pods are described in the following documents: WO-A1-2010/006979 discloses a method for manufacturing a pod and its associated pod comprising ground coffee covered on at least partly by a structuring component, such as agar; FR-A1-2.879.175 discloses a pod enclosed in an envelope made by coating a compacted aggregate of coffee with a food composition made of sugar, coffee or milk. The coating gives the pod its cohesion.

However, the structuring products used to date have not been neutral and drinks prepared using this type of portion have rather poor taste.

There is therefore a need for a portion of infusible product that reduces the number of packages required while providing customers with good taste qualities.

To achieve this, the present invention relates to a portion of infusible material with a she and a core. The applicant has found that by compacting the ground coffee so as to form a compact shell surrounding a core of ground coffee, he has been able to obtain a portion which has both satisfactory cohesion and taste properties similar to those of loose ground coffee.

Moreover, the spherical shape of the shell is particularly advantageous. Indeed, the compression of the ground coffee in spherical form in order to create the shell prevents the creation of stress concentration points resulting in weak zones that lessen the cohesive properties and strength of the portion.

According to one embodiment, the portion according to the invention consists of a shell with good cohesive properties and raised relief shapes formed on the surface of the shell. Reliefs penetrating at least partially into the shell are intended to enhance the penetration of water or any other fluid through the said shell.

Other aims and advantages will appear in the illustrative but not restrictive description of a preferred embodiment which follows.

The present invention relates to a portion of material to be infused for preparing a beverage characterised in that said portion includes a spherical shell made of compacted ground coffee and a core of ground coffee.

According to preferred but not restrictive embodiments, the portion according to the invention is such that:
the compacting pressure of the ground coffee forming the shell is greater than that of the ground coffee forming the core,
the shell comprises 2 to 8 concentric layers of ground coffee with a pressure of compaction that decreases towards the centre of the portion,
the ground coffee forming the shell is compacted at a pressure of 5 to 20 times the compaction pressure of the ground coffee forming the core,
the portion is equipped with at least one duct formed at least in part through the shell inwards in the direction of the core of the portion so as to promote the penetration of the fluid inside the portion,
at least one duct is arranged on a radius of the spherical shell in the direction of the core,
the portion comprises 8 to 15 ducts with lengths of 2 to 5 mm and a diameter of 0.5 to 2 mm,
the at least one duct leads to the outer surface of the shell,
the at least one duct is of substantially conical shape, widening towards the outer surface of the shell,
the density of the she is between 0.60 and 1 g/cm³,
the ground coffee forming the core is loose.

The invention also relates to a method of manufacture characterised in that the ground coffee forming the she is compacted at a pressure of between 200 and 500 bar, i.e. from 20 to 50 megaPascals (MPa).

According to one embodiment, the method is such that the shell is formed by compressing the ground coffee at a temperature of between 35 and 100° C.

The invention also relates to the use of such a portion for preparing a beverage by percolation at a high pressure of between 14 and 20 bars, that is to say 1.4 to 2 MPa.

The drawings attached are given by way of examples and are not exhaustive, They represent only one embodiment of the invention and will make it possible to understand it easily.

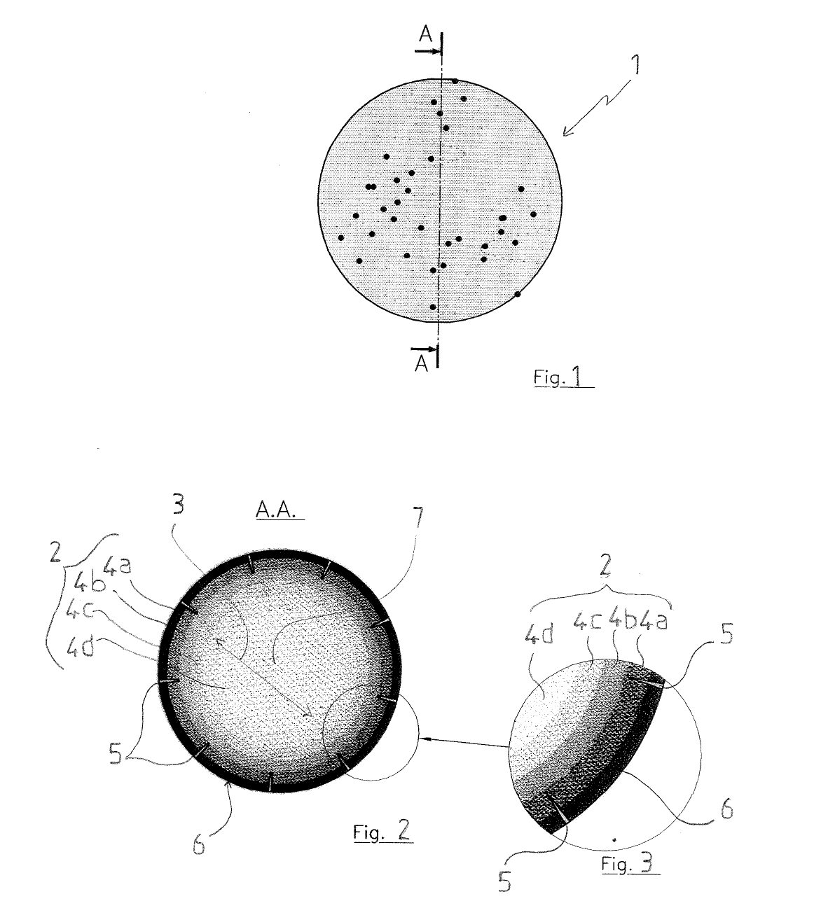

FIG. 1 shows a view of the portion according to the method of making a spherical portion.

FIG. 2 is a sectional view on A-A of FIG. 1 and FIG. 3 gives a detailed view of it.

The present invention consists of a portion 1 of material to be infused for preparing a beverage.

The material to be infused is ground coffee. By ground coffee is meant roasted coffee beans that are ground. The ground coffee used for the present invention is very finely to averagely ground. More precisely, the grind is 0.4 to 2 mm, for example 1 mm.

Portion 1 according to the invention comprises ground coffee and preferably ground coffee alone. It does not comprise filter paper. Nevertheless, additives can be used, especially for the shell 2, so as to enhance its cohesion or liquid tightness. Agar can be such an additive. Preferably, the only additive(s) is a preservative.

Portion 1 comprises a shell 2 and a core 3. The shell 2 is made of compacted ground coffee so as to enclose the core 3 consisting of ground coffee.

By shell 2 is meant the most peripheral part of the portion 1.

The ground coffee forming the shell 2 is compacted so as to impart strength to the portion 1 and allow it to be handled by the user.

The she 2 encloses the core 3 consisting of ground coffee, The shell 2 is compacted.

In a first embodiment, the ground coffee contained in the core 3 is compacted at a compaction pressure that is less than the pressure applied to the she 2.

According to a second embodiment, the ground coffee forming the core 3 is not compacted, that is to say, is loose. This embodiment has the advantage of not significantly altering the infusion properties of the ground coffee contained in the core 3 compared to conventional conditions.

According to a third embodiment, the shell comprises at least two layers 4a to 4d of coffee, one of which, the innermost, is compacted by the application of a compaction pressure that is less than the outermost layer, Preferably, the layers 4a to 4d of the shell 2 are superposed so that the compacting pressure decreases inwardly towards the centre of the portion 1. The shell 2 comprises up to eight of the layers 4.

For example, the layer 4a, the outermost layer of the shell 2, is compacted at a pressure of around 400 bars, i.e. 40 MPa. Each successive layer 4 has a compaction pressure that decreases towards the centre of the portion 1 of 25 bars: i.e. 400 bars, i.e. 40 MPa, for the layer 4a-375 bars, i.e. 37.5 MPa, for the layer 4b-350 bars, i.e. 35 MPa, for the layer 4c, and 325 bars, i.e. 32.5 MPa, for the layer 4d in the direction of the core 3.

The presence of the layers 4 forming the shell 2 helps to improve the infusion of the product to be infused by the liquid in order to produce the beverage. Indeed, the liquid gradually penetrates inside the portion 1.

As shown on the figures, the portion 1 is spherical. In particular, the shell 2 is spherical. However, the portion 1 may adopt other shapes, including oval, saucer, etc.

The spherical shape is preferred because it allows the shell 2 to be compacted evenly. No areas of stress concentration that could weaken the shell 2 are created. The portion 1 made in this way has no angles or protrusions that could be damaged during transport, storage or handling of the portion.

The portion 1 according to the invention has good resistance to disintigration: by allowing the portion to fall from a height of 1.5 m onto a hard flat surface, the amount of ground coffee that separates from the portion 1 is between 2 and 10% by weight of the portion, and more specifically between 2 and 7%.

For example, the portion comprises between 5 and 15 g of ground coffee and more precisely 7 to 10 g. The portion 1 has a diameter of 1.5 to 5 cm, and more precisely from 2 to 4 cm.

The shell 2 represents between 5 and 40% of the volume of the portion 1, and preferably around 20%. This ensures that the taste of the drink produced by a portion 1 is very satisfactory, most of the ground coffee that is infused is lightly compacted ground coffee which is protected from the air, dampness and light by the shell 2.

The thickness of the shell 2 is between 3 and 15 mm. The layers 4a to 4c have a thickness that is substantially equal to one another. In a preferred arrangement, the core 3 is the innermost part of the portion 1 which is the thickest of the portion 1. The core 3 comprises advantageously a central zone 7.

As shown on FIGS. 2 and 3, the layers 4 and the core 3 of the portion 1 are concentric. This arrangement of the portion 1 with a shell 2 made of ground coffee compacted at a greater pressure than the ground coffee inside the core 3 of the portion is 1 makes it possible to use the portion 1 in espresso drinks machines in particular. By espresso is meant percolation under high pressure. Water is sprayed onto the portion 1 at a pressure of between 13 and 20 bars, i.e. 1.3 to 2 MPa, and preferably around 16 bars, i.e. 1.6 MPa.

The shell 2 has a density of between 0.6 and 1 g/cm³. Thus, when making a drink, the shell 2 is exposed first to the liquid, such as pressurised water.

According to a first possibility, the shell 2 will be gradually imbibed with water until it loses its cohesion so that the core 3 is in turn exposed to the liquid. When the shell 2 consists of several layers 4, this imbibing phenomenon takes place progressively. It is preferable that the central zone 7 consists of loose ground coffee so that the infusion of the portion 1 as a whole produces a drink whose taste quality is substantially the same as that of an espresso coffee produced with a ground coffee hand-packed before percolation.

In another arrangement, the shell 2 is imbibed but retains its cohesion. This can occur when the shell 2 is sufficiently compacted with respect to the time required to make and infuse the drink.

According to one embodiment of the invention, the portion 1 has a raised shape formed at least in part inside the shell 2. This relief consists for example of the 5 ducts passing at least partially through the shell 2 and passing preferably also at least partially the core 3. When the shell 2 comprises several layers 4, the ducts 5 pass through at least the outermost layer 4.

This relief is intended in part to facilitate the intake of liquid into the portion 1 and in particular to bring it more quickly to the core 3 of the portion 1. The liquid enters the ground coffee of the core 3 without requiring that the she 2 be entirely imbibed. There is no need for the she 2 to disintegrate.

According to this arrangement, the shell 2 remains intact before and at least partly during part of the production of the drink. Preferably, the shell 2 also remains intact after the drink has been made, This is particularly advantageous as the infusion chamber of the drinks making machine receiving the portion 1 will not be stained by the ground coffee and will not require rinsing before its next use.

It will be noted that this version allows the coffee forming the core 3 to be infused in conventional conditions. At the same time, the container of the core 3 coffee, that is to say the shell 2, is also made of coffee so that no constituent products that can affect the taste or no non-degradable waste is used to make the portion 1.

According to one embodiment, the relief is formed by the ducts 5 that have a preferred conical rectangular shape.

The ducts 5 are preferably arranged along a transversal axis of the portion 1 and more especially on a radius of the portion 1 when the latter is spherical. When the ducts 5 are conical as shown in FIGS. 2 and 3, they exit on the outer surface 6 of the shell 2 and are flared towards this outer surface 6 of the shell 2.

The number of ducts 5 is variable and they are preferably uniformly distributed on the surface of the portion 1. The ducts 5 are preferably 2 to 20 mm long with a section of 0.5 to 2 mm.

For example, a portion of 4 mm section comprises 8 to 15 ducts 5 with a length of 2 to 5 mm and/or 0.5 to 2 mm section.

This relief may have various shapes.

According to the possibility wherein the shell 2 does not disintegrate during percolation, the preferred arrangement is that the reliefs act both to promote the intake of water inside the portion 1 but also the outflow of the beverage from the portion 1. For this purpose, it is advantageous that the relief, at least the one on the region of the portion 1 used for the outflow of the drink, is a duct or hole with a section of smaller diameter than the ground coffee, particularly in the core 3. In this way, the shell 2 uses the relief to act as a filter.

According to another embodiment, the ground coffee comprising the shell 2 is compacted to form cells and/or interstices between the grains of ground coffee. These cells and/or interstices have a dual role which is to facilitate both the intake and the outflow of water in the core of the portion 1. In addition, it is preferred that the cells and/or interstices are smaller than those of the ground coffee, at least those of the core 3 so as to act as a filter.

In order to prepare a beverage according to the invention, the shell 2 around the core 3 is compacted at a pressure of between 200 and 500 bars, i.e. 22 to 50 MPa. Furthermore, the shell 2 may be compacted at a temperature of between 35 and 100° C. In this way, the ground coffee forming the shell 2 has greater cohesion since the ground coffee has been heated leading to the fusion of the ground coffee.

The heating method is preferably used to manufacture a portion in which the ground coffee of the shell 2 is not intended to disintegrate and therefore offers slight infusion.

### REFERENCES

1. Portion

2. Shell

3. Core

4. Layer

4a. Layer

4b. Layer

4c. Layer

4d, Layer

5. Ducts

6. Outer surface of the shell

7. Central zone

1. A portion of a substance to be infused to prepare a beverage wherein the said portion comprises a spherical shell made of compacted ground coffee and a core made of ground coffee.

2. Portion according to the claim 1 wherein the compacting pressure applied to the ground coffee forming the shell is greater than that of the ground coffee forming the core.

3. Portion according to claim 1 wherein the shell comprises 2 to 8 concentric layers of ground coffee with a compaction pressure that decreases towards the centre of the portion.

4. Portion according to claim 1 wherein the ground coffee forming the shell is compacted at a compacting pressure of 5 to 20 times the compaction pressure for the ground coffee forming the core.

5. Portion according to claim 1 comprising at least one duct formed at least in part through the shell in the direction of the core of the portion so as to promote a penetration of a fluid inside the portion.

6. Portion according to claim 5 wherein the at least one duct is arranged on the radius of the spherical shell in the direction of core.

7. Portion according to claim 5 comprising 8 to 15 ducts with lengths of 2 to 5 mm and a diameter of 0.5 to 2 mm.

8. Portion according to claim 5 wherein the at least one duct opens on the outer surface of the shell.

9. Portion according to claim 5 wherein the at least one duct is substantially conical in shape widening towards an outer surface of the shelf.

10. Portion according to claim 1 wherein the shell has a density of between 0.6 and 1 g/cm³.

11. Portion according to claim 1 wherein the ground coffee of the core is loose.

12. Method of manufacturing a portion according to claim 1 wherein the ground coffee used to form the shell is compacted at a pressure of between 20 and 50 MPa.

13. Method according to claim 12 in which the shell is formed by compacting the ground coffee at a temperature of 35 to 100° C.
